(19) United States
(12) Patent Application Publication
(10) Pub. No.: US 2015/0324316 A1
(43) Pub. Date: Nov. 12, 2015

(54) COMPUTING DEVICE WITH A MODULE

(71) Applicants: Payam Moradian, Los Angeles, CA (US); Keith Andrew Kurtz, Northridge, CA (US)

(72) Inventors: Payam Moradian, Los Angeles, CA (US); Keith Andrew Kurtz, Northridge, CA (US)

(21) Appl. No.: 14/272,271

(22) Filed: May 7, 2014

(51) Int. Cl. G06F 13/40; H04W 4/00

(52) U.S. Cl. CPC G06F 13/4081; H04W 4/008

(57) ABSTRACT

Provided are computing devices that use a module and can exhibit different interfaces. In one embodiment provided is a mobile computing device comprising: a body in shape of a module having two parallel flat surfaces; a processor and a memory placed inside the body; and a docking port at end of the body between the parallel flat surfaces for detachably attaching to a monitor to obtain an electronic connection wherein the computing device is attached to the monitor by resting on one of the flat surfaces to provide one or more of a cellular phone, a laptop computer, a personal computer, a tablet computer, or a watch.

### BACKGROUND SECTION OF THE INVENTION

Today there are many personal electronic devices that a user may use during a day, including a personal computer, a tablet computer, and a mobile phone. It is difficult to manage data present on all these various personal devices. A user may have to constantly transfer data from one device to another. There is a need in the art to make it easier for a user to use multiple personal electronic devices.

### SUMMARY SECTION OF THE INVENTION

Provided is a mobile computing device comprising: a body in shape of a module having two parallel flat surfaces; a processor and a memory placed inside the body; and a docking port at end of the body between the parallel flat surfaces for detachably attaching to a monitor to obtain an electronic connection, wherein the computing device is attached to the monitor by resting on one of the flat surfaces to provide one or more of a cellular phone, a laptop computer, a personal computer, a tablet computer, or a watch. The computing device can further comprise a network processor capable of communicating with a tower so that when the module is attached to the monitor, the cellular phone with capability to form a connection with the tower is obtained. A local wireless network such as Wi-Fi can also be used. The computing device can be capable of being attached to a first monitor to provide a cellular phone and to a second monitor to provide a personal computer. The module can be a cuboid with sharp or smooth edges. The module can have a width of about 1 to about 3 inches, a length of about 2 to about 4 inches, and a height of about 0.15 to about 0.50 inches. The module can have a width of about 1 to about 2 inches, a length of about 2 to about 3 inches, and a height of about 0.25 inches. The module can have a width of about 2 inches, a length of about 3 inches, and a height of about 0.25 inch. The module can be placed in a slot of a watch. The module can have storage, power management, and multiple access unit.

Provided is a multi-module computing device comprising two or more modules dividing functions of memory, processor, storage, and network, with each module comprising: a body in shape of a module having two parallel flat surfaces for resting on a flat surface of a monitor; a first male and a second female docking port at a first and a second end of the body on opposite sides of the body between the parallel flat surfaces, wherein the second docking port can receive another module and the first docking port can be detachably attached to the second docking port; one to three of memory, processor, storage, and network processor placed in the body; wherein detachable electronic connection of the modules provides a computing device having memory, processor, storage, and network capability; wherein the two or more modules are attached to a monitor by resting on one of the flat surfaces to provide one or more of a cellular phone, a laptop computer, a personal computer, a tablet computer, or a watch. Each module can be randomly attached to another module. The computing device is made from four modules with each having one of the following: memory, processor, storage, and network processor. The computing device can have one of the modules capable of detecting a new module, identifying the new module, and integrating the new module into the computing device. The module can be a processor module. Each of the modules can have a width of about 1 to about 2 inches, a length of about 2 to about 3 inches, and a height of about 0.25 inches. Each of the modules can have a width of about 2 inches, a length of about 3 inches, and a height of about 0.25 inch. Each of the modules can have a width of about 1 inch, a length of about 2 inches, and a height of about 0.2 inch.

Provided is a wearable computing device comprising: a processor, a memory, storage, a power source, a first network processor for transmitting and receiving data from a cellular or microwave tower, a second network processor for transmitting and receiving data from a monitor that is visible to a user, wherein the wearable device acts as an intermediate transmission device between the monitor and the tower. The wearable device can be selected from one or more of a watch, a card sized device to be put in a purse or wallet, or a device attached to a key chain. The wearable device can have a radiation shield.

Provided is a method for making a cellular phone, a laptop computer, a personal computer, a tablet computer, or a watch, comprising attaching a module to a monitor to give one of said devices. The method can further comprise the step of determining based on the size of the monitor an interface that is suitable.

Provided is a method of making a multi-module system comprising, designating a first module for attachment to a monitor, the first module having a plurality of ports, attaching one ore modules to the first module. The method can further comprise a computer implemented method for detecting a connection, identifying the module, and integrating the module.

Provided is a method of making a multi-module system comprising, attaching two or modules with separate functionalities to each other, wherein the system allows for any order of attachment. The method can further comprise a computer implemented method for detecting a connection, identifying the module, and integrating the module.

Provided is a method of communicating comprising transferring data wirelessly from an external source (tower, internet) to a wearable device, transmitting data from the wearable device to a monitor. The wearable device can present some, all, or none of the data to a user.

### BRIEF DESCRIPTION OF THE FIGURES

FIG. 1 illustrates a computing device module that can be attached to a monitor.

FIG. 2 illustrates a computing device module that can be attached to a monitor.

FIG. 3 illustrates a computing device module that can be attached to a monitor.

FIG. 4 illustrates the exemplary internal components of the computing device module.

FIG. 5 illustrates a monitor with a port in a slot for receiving a module.

FIG. 6 illustrates a monitor with a slot for receiving a module.

FIG. 7 illustrates a slot in a watch for receiving a module.

FIG. 8 illustrates a module with optional display and indicator lights.

FIG. 9A illustrates a multi-module design.

FIG. 9B illustrates a multi-module design.

FIG. 10 illustrates integrating modules into a multi-module system.

FIG. 11 illustrates a wearable device that can communicate both with a tower and a monitor.

FIG. 12 illustrates a different interface that is presented depending on the monitor.

### DETAILED DESCRIPTION OF THE INVENTION

The present invention provides a computing device in a module (2) that can be attached to any monitor (42) (44) to obtain various devices, including a cellular phone, a personal computer, a tablet computer, and a smart watch. The computing device (2) is mobile and it attached along its flat surface to a monitor, so that for example, the cellular phone can be held with the hand. In some embodiments, the computing device is made from multiple modules (59)(60)(61)(62), allowing a user to customize the computing device.

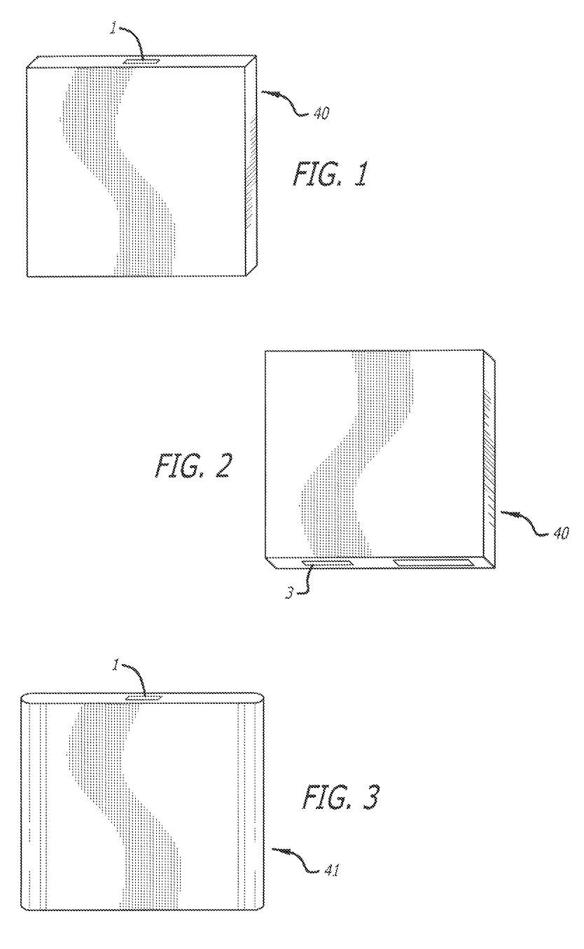

FIGS. 1-3 illustrate a computing device module (2) that can be attached to a monitor. The module (2) can have a male or female docking port (1) for electronic connection with the monitor. The computing device module can have slots (3) for placing memory or other types of cards. FIG. 3 illustrates the computing device module (2) with round edges (41). The edges (40) are sharp in FIGS. 1 and 2.

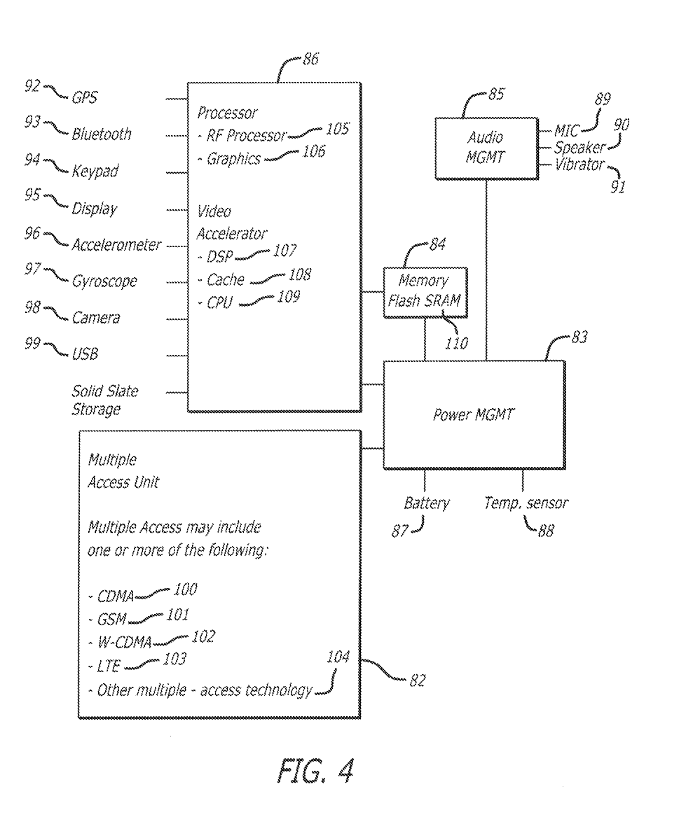

FIG. 4 illustrates the exemplary internal components of the computing device module (2), in this case a logic board that is placed inside the module (2). The computing device can have a processor (86) that includes a CPU (109), cache (108), DSP (107), graphical video accelerator (106), and an RF processor (105). The processor (86) can be electronically in communication with peripherals present on the monitor, such as GPS (92), Bluetooth (93), keypad (94), display (95), accelerometer (96), gyroscope (97), camera (98) and USB (99). The computing device module (2) can have a multiple access unit (82) that includes CDMA (100), GSM (101), W-CDMA (102), LTE (103), and other related multiple access technology (104). The computing device module (2) can have a power management system (83) in electronic communication with a battery (87) and/or a temperature sensor (88) on the monitor. The computing device module (2) can have memory (84), such as flash (84), or SRAM (110). The computing device module (2) can also have an audio management unit (85), which can be in communication with a microphone (89), speaker (90), and/or vibrator (91) on the monitor.

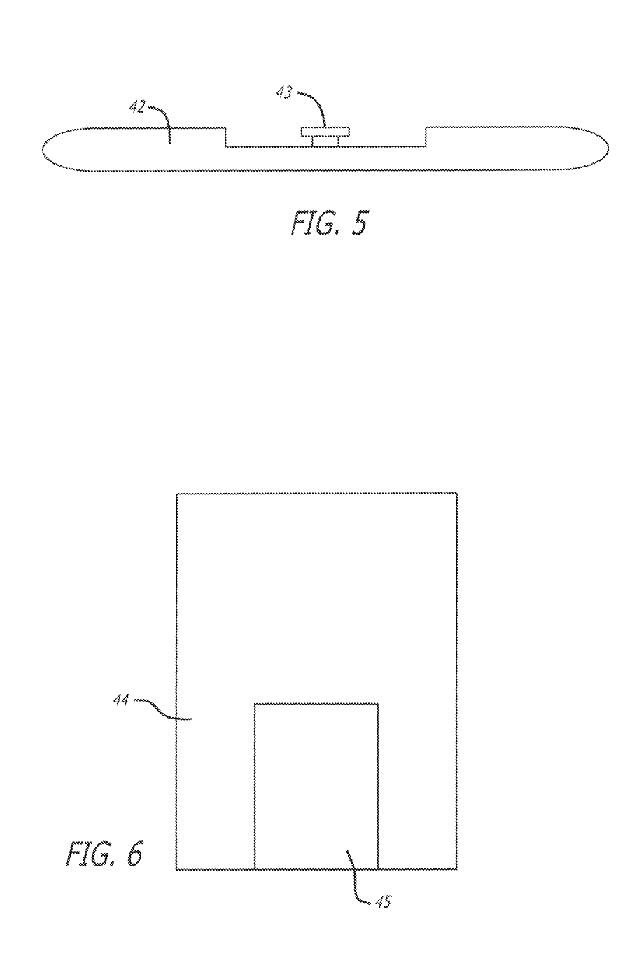

FIGS. 5-6 illustrate sliding the same computing device module (2) in a computer (42) or a mobile phone (44). In FIG. 5, a side view of the top is shown that can be that of a monitor that would give a laptop, personal computer, or a tablet computer. The monitor can come with features that are ordinary present in these devices (such as peripherals listed in FIG. 4). The male docking port (1) of computing device module (2) slides into a slot and is then electronically connected to the mating female port (43) of the monitor. FIG. 6 illustrates a mobile phone having a slot (45) in which the computing device module (2) slides or is placed into. The slot can have a door so that the module is fully enclosed. In one embodiment, the monitor is that of size of a cell phone and has a battery, camera, and other peripherals associated with a mobile phone.

In one embodiment, cellular phone, tablet computer, and/or the personal computer are fully functional without the computing device, and attachment of the computing device module allows for the module over riding the processor of the device to which it is attached. In one embodiment, cellular phone, tablet computer, and/or the personal computer are not functional without the computing device, and attachment of the computing device module allows for the module acting as the main computing device.

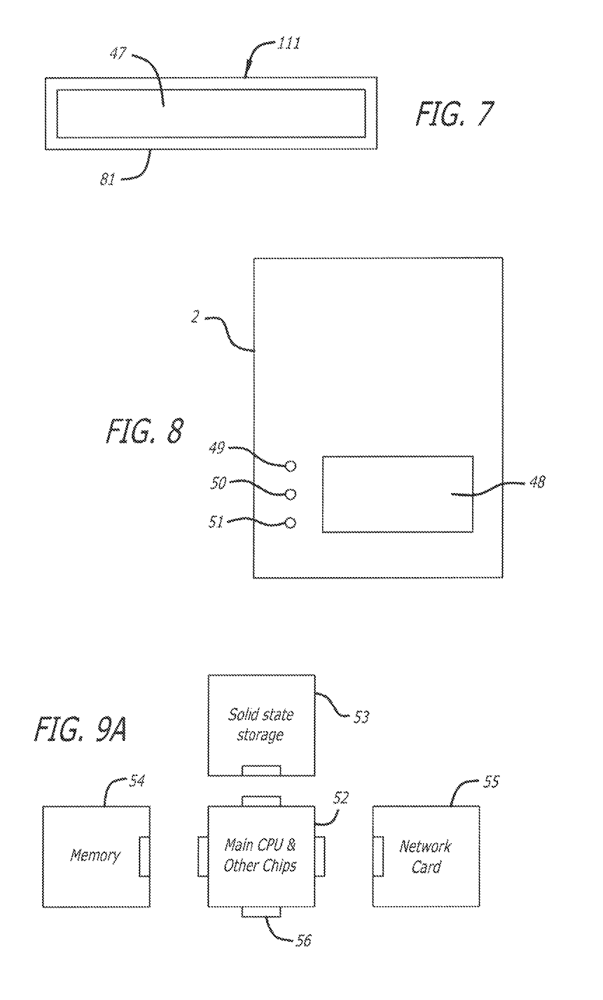

FIG. 7 is a side view of a watch (111) having a slot (47) in which computing device module (2) slides. The watch (111) can be functional or non-functional without the module. Without the module, for example, the watch may be capable of keeping time but not be a “smart watch.” Alternatively, the module can give a smart watch the ability to connect to a network. The watch can have a radiation shield (81) to reduce microwave radiation penetrating into the arm.

FIG. 8 illustrates the computing device module (2) of FIGS. 1-3 with optional display (48) and indicator lights (49, 50, 51) for providing status of the module, such as giving a warning light if one or more parts of the module are not functioning.

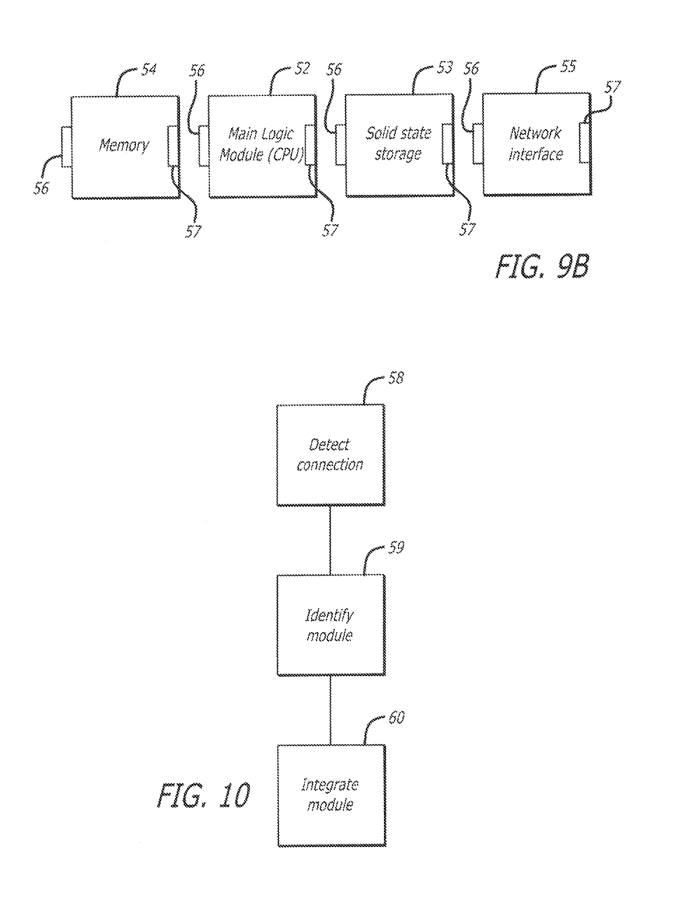

FIG. 9A illustrates a multi-module design. In this design, the computing device module (2) is broken up into multiple modules (52, 53, 54, 55). For example, there is a module for memory (53), a module for solid state storage (53), a module for main CPU and other processors (52), and a module for a network card (55). In this design, all the modules are connected to the CPU module (52), and then the CPU module is connected though docking port (56) to the electronic device. This design allows for user to choose the different modules to be plugged into the main CPU module (52). FIG. 9B illustrates the same concept except that any module (52, 53, 54, 55) can be attached to another module in any order. Each module has a male (56) and a female (57) docking port on opposite sides, and can be detachably connected to each other. As shown in FIG. 9B, the memory module (54) is connected to the electronic device, followed by the main logic unit (CPU) (52), followed by solid state storage (53), and finally network interface (55). Any order can be used. The modules can be made to be securely attached to each other so they do not come apart.

FIG. 10 illustrates the steps taken to incorporate modules 52, 53, 54, and 55. The main module can contain handling hardware and software that detects a connection (58) and identifies auxiliary modules (59) such as memory, solid-state storage, and network interface. Upon detection and identification of a new module, handler utilities can be invoked to integrate the module (6) into the system.

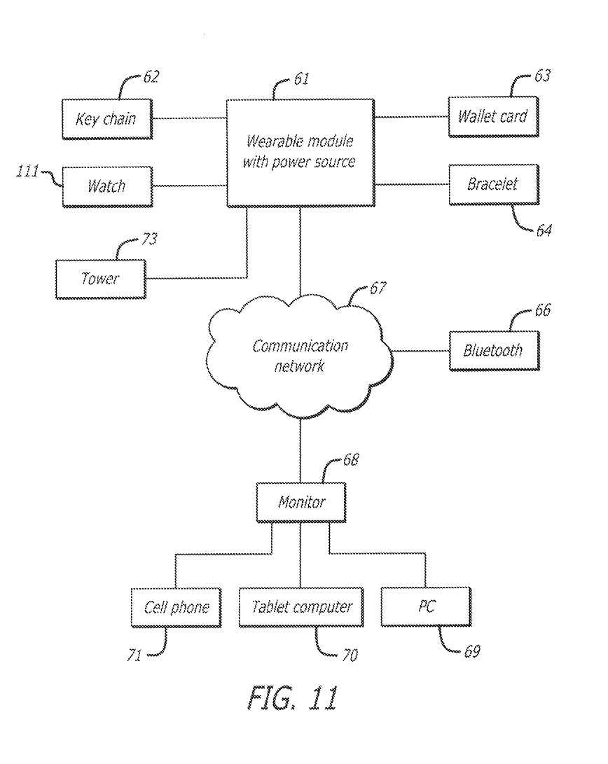

FIG. 11 illustrates a wearable module (61) with a power source such as a rechargeable battery. The wearable module can be a watch (111), key chain (62), wallet card (63) or a bracelet (64). The wearable module can communicate through a communication network (67) with a monitor (68). The monitor (68) can be used as a cell phone (71), (tablet computer (70), or a personal computer (69) depending on the size of the monitor (68). The monitor and the wearable module can have a receiver and a sender that effectively communicate with each other and transfer data. The monitor (68) can be a dumb monitor that only becomes a computing device after communication with the wearable module (61). The wearable module (61) can also optionally connect to a tower (73), satellite or other signal source to transfer data and be capable of receiving cellular data and/or internet. With the wearable module (61), a user can receive internet and cellular phones, and relay those to a monitor (68) that can have a speaker and a microphone to obtain a smart phone.

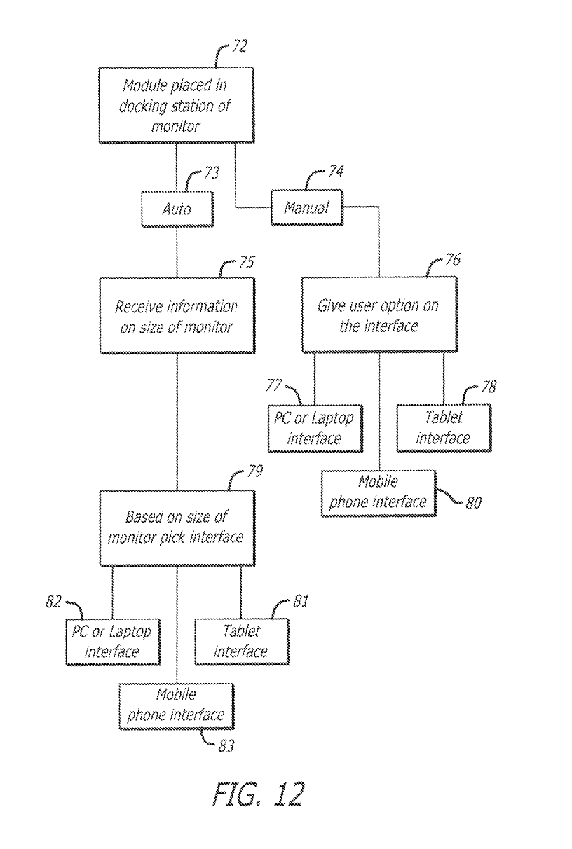

FIG. 12 illustrates the obtained computing device providing a different interface depending on the computing device obtained after attachment of a module (such as modules in FIG. 1 or 9). In this embodiment, the module (72) is placed in docking station of a monitor (68). The computing device present in the module can then output a desired interface wither automatically (73) or manually (74). In automatic mode, the module receives information on the size of the monitor (75), and then based on the size of the monitor (79) can provide a PC or laptop interface (82), tablet interface (81), or a mobile phone interface (83). In manual mode (74) a user is given an option on the interface (76), and then the user selects a PC or laptop interface (77), tablet interface (78), or a mobile phone interface (79).

The module of FIG. 1-3 or 9 can have a width of about 1 to about 3 inches, a length of about 2 to about 4 inches, and a height of about 0.15 to about 0.50 inches. In one embodiment, the module has a width of about 1 to about 2 inches, a length of about 2 to about 3 inches, and a height of about 0.25 inches. In one embodiment, the module has a width of about 2 inches, a length of about 3 inches, and a height of about 0.25 inch. In one embodiment, the module has a width of about 1 inch, a length of about 2 inches, and a height of about 0.2 inch.

The module resting on a surface refers to partial or full contact of one of the parallel surfaces of the module with a surface of a monitor. The surface of the monitor is usually behind the monitor where the module rests against and allows for holding a computing device such as a phone or a tablet computer in hand. There can be a cavity behind the monitor for receiving the module, and a door for enclosing the module inside the cavity. The length of the module (longest side) can be in parallel to the length (longest side) of the monitor.

What is claimed is:

1. A mobile computing device comprising:
a body in shape of a module having two parallel flat surfaces;
a processor and a memory placed inside the body; and
a docking port at end of the body between the parallel flat surfaces for detachably attaching to a monitor to obtain an electronic connection;
wherein the computing device is attached to the monitor by resting on one of the flat surfaces to provide one or more of a cellular phone, a laptop computer, a personal computer, a tablet computer, or a watch.

2. The computing device of claim 1, further comprising a network processor capable of communicating with a tower or a wireless network so that when the module is attached to the monitor, the cellular phone with capability to form a connection with the tower or the wireless network is obtained.

3. The computing device of claim 1, wherein the computing device is capable of being attached to a first monitor to provide a cellular phone and to a second monitor to provide a personal computer.

4. The computing device of claim 1, wherein the module is a cuboid with sharp or smooth edges.

5. The computing device of claim 1, wherein the module has a width of about 1 to about 3 inches, a length of about 2 to about 4 inches, and a height of about 0.15 to about 0.50 inches.

6. The computing device of claim 1, wherein the module has a width of about 1 to about 2 inches, a length of about 2 to about 3 inches, and a height of about 0.25 inches.

7. The computing device of claim 1, wherein the module has a width of about 2 inches, a length of about 3 inches, and a height of about 0.25 inch.

8. The computing device of claim 1, wherein the module can be placed in a slot of a watch.

9. The computing device of claim 1, further comprising the module having storage, power management, and multiple access unit.

10. A multi-module computing device comprising two or more modules dividing functions of memory, processor, storage, and network, with each module comprising:
a body in shape of a module having two parallel flat surfaces for resting on a flat surface of a monitor;
a first male and a second female docking port at a first and a second end of the body on opposite sides of the body between the parallel flat surfaces, wherein the second female docking port can receive another module and the first male docking port can be detachably attached to the second docking port;
one to three of memory, processor, storage, and network processor placed in the body;
wherein detachable electronic connection of the modules provides a computing device having memory, processor, storage, and network capability;
wherein the two or more modules are attached to a monitor by resting on one of the flat surfaces to provide one or more of a cellular phone, a laptop computer, a personal computer, a tablet computer, or a watch.

11. The computing device of claim 10, wherein each module can be randomly attached to another module.

12. The computing device of claim 10, wherein the computing device is made from four modules with each having one of the following: memory, processor, storage, and network processor.

13. The computing device of claim 10, further comprising having one of the modules capable of detecting a new module, identifying the new module, and integrating the new module into the computing device.

14. The computing device of claim 13, wherein the module that carried out the detecting, is the processor module.

15. The computing device of claim 10, wherein each of the modules have a width of about 1 to about 2 inches, a length of about 2 to about 3 inches, and a height of about 0.25 inches.

16. The computing device of claim 10, wherein each of the modules have a width of about 2 inches, a length of about 3 inches, and a height of about 0.25 inch.

17. The computing device of claim 10, wherein each of the modules have a width of about 1 inch, a length of about 2 inches, and a height of about 0.2 inch.

18. A wearable computing device comprising:
a processor,
a memory,
storage,
a power source,
a first network processor for transmitting and receiving data from a cellular or microwave tower,
a second network processor for transmitting and receiving data from a monitor that is visible to a user,
wherein the wearable device acts as an intermediate transmission device between the monitor and the tower.

19. The wearable device of claim 18, wherein the wearable device is selected from one or more of a watch, a card sized device to be put in a purse or wallet, or a device attached to a key chain.

20. The wearable device of claim 18, wherein the wearable device has a radiation shield.
